(19) United States
(12) Patent Application Publication
(10) Pub. No.: US 2022/0305919 A1
(43) Pub. Date: Sep. 29, 2022

(54) GRAYSON RANGE EXTENDER (GRE) 2.0: Fluid Dynamic Kinetic Energy-based Frictionless Generator Type Range Extender and Recharger for Electric Vehicles and the Production of Electricity

(71) Applicant: Michael Curtis Grayson, Hollis, NY (US)

(72) Inventor: Michael Curtis Grayson, Hollis, NY (US)

(21) Appl. No.: 17/471,745

(22) Filed: Sep. 10, 2021

Related U.S. Application Data
(63) Continuation-in-part of application No. 17/210,654, filed on Mar. 24, 2021.

(51) Int. Cl. B60L 8/00; B60L 50/62; F03D 3/00; F03D 9/32; F03D 9/11

(52) U.S. Cl. CPC B60L 8/006; B60L 50/62; F03D 3/002; F03D 9/32; F03D 9/11; F03D 3/065

(57) ABSTRACT

A fluid dynamic kinetic energy-based frictionless type generator of a range extender and recharger for an electric vehicle or device and the production of electricity is characterized by converting fluid motion into electric energy. This device uses the drag force acting opposite to the relative motion of objects moving with respect to a surrounding fluid. This force can exist between two fluid layers or a fluid and a solid surface. The device comprises a cylinder covered with paddles, air ducting ramp, permanent magnets, armature winding, charge controller and battery bank. It's a frictionless, high efficiency, brushless generator design that utilizes kinetic energy produced by drag, pressure, friction, fluid resistance, fluid dynamics, aerodynamics, wind, and or motion together with the device itself to create a frictionless brushless generator that will deliver power to the engine directly, the enclosed battery bank or can be diverted to the vehicle battery bank for recharging.

### CROSS-REFERENCE TO RELATED APPLICATIONS

The present invention is a U.S. Continuation-in-Part application that claims priority to U.S. Nonprovisional patent application Ser. No. 17/210,654, entitled “GRAYSON RANGE EXTENDER (GRE) 2.0: Fluid Dynamic Kinetic Energy-based Frictionless Generator Type Range Extender and Recharger for Electric Vehicles and the Production of Electricity,” filed on Mar. 24, 2021; the entire disclosure of which is incorporated herein by reference.

### TECHNICAL FIELD

Aspects described herein relate to a fluid dynamic kinetic energy-based frictionless type generator of a range extender and recharger for an electric vehicle or device, wherein the production of electricity is characterized by converting fluid motion into electric energy.

### BACKGROUND

Although pure electric vehicles have the advantage of energy-savings, environmental protection, and zero discharge, the continual mileage range is currently very limited. In order to achieve mass application and acceptance the electric vehicle, the range must meet or exceed that of conventional fossil fuel powered vehicles. Currently 400 miles is the average range for a fossil fuel vehicle. This range has become standard and is very consumer friendly because of the fact that there is a wide choice of gas stations available and refueling takes only five minutes. It would be very easy to give gas cars a higher range, just put in a bigger tank. For electric vehicles the solution is not as simple. The average range of an electric vehicle is currently 150 miles. Adding more battery as the solution for perceived range needs only adds more cost to the profitability-challenged electrified vehicle. Vehicle Costs Already Too High for Mainstream Customers and given the inherent cost disadvantages faced by EV's vs. conventional vehicles and less financial policy support in the future, even the current $50 per additional mile of cost to the vehicle is quite impractical, given the number/frequency of trips that truly require most of the battery range. Larger batteries will also incur larger warranty expenses for the OEM as well as greater freight & recycling costs.

More Mass on the Vehicle. Batteries are very heavy. Compensating with Lightweight Materials is Expensive. In order to meet very stringent fuel economy & CO2 targets globally (primarily China, Europe, US & CA), all vehicles will have to be lighter and more mass efficient. Automotive OEM's will pay more in premium materials for weight savings. Adding 4 lbs. of battery mass is roughly equal to 1 mile of EV range.

Longer Charging Times to Top-off. Charging Infrastructure for Long Distance Trips under currently under Development however no solution is close at hand.

Key Customers today are very accustomed to short re-fueling times at gas stations. Charging an EV is a much different experience and has been a challenge since the days of Edison's efforts to supply the first batteries for electric cars. The larger the batteries become, the more and faster charging solutions that are required and continuous high-power charging can increase battery degradation.

Less Packaging Space for other Components. More Stuff on Vehicles Expected with High Tech Features and Autonomous driving leaves less room for batteries and not more. As batteries become larger to provide more range, given a fixed vehicle size, packaging of components and new features become an acute challenge for all of the elements requiring space within the vehicle architecture including passenger and cargo carrying expectations. Future self-driving systems will further accentuate this issue as well as require more energy consumption.

More Structural Requirements for Crashworthiness. Must Protect the Bigger Batteries. We are often reminded that both gas tanks and batteries contain so much energy and they need to be carefully protected from thermal events that can occur during crashes. Larger batteries are greater engineering challenges requiring more substantive structures/systems.

More Robust Support Systems Required Mass Begets Mass As the battery grows and the mass of the vehicle increases, other components from brakes, suspension, thermal management, etc. must be designed and reinforced to handle these challenges; the result is even more mass and cost added to the vehicle.

Without solutions to all these problems the electric vehicle just cannot advance. The GRE 2.0 addresses each of these problems in a practical, reliable and cost-effective way. My fluid dynamic paddle based permanent magnet generator has the advantage of high efficiency, high power density, and has more wide application prospect.

In existing technology, the GRE will prove to be a compatible device that can quickly integrate with all current electrical vehicle platforms. The present invention proposes the conversion of the vehicle fluid dynamics into rotational energy that moves a permanent magnet generator. In fluid dynamics, drag (sometimes called air resistance, a type of friction, or fluid resistance, another type of friction or fluid friction) is a force acting opposite to the relative motion of any object moving with respect to a surrounding fluid.

### SUMMARY

In order to gain exponential range extension, provide more power for greater horsepower, create a platform that will have immediate and long-term environmental benefits while simultaneously reducing charging times, improving EV overall efficiency, the present invention adopts the following technical scheme:

A kind of electric vehicle recharging system that greatly extends the range of any vehicle, said paddle-based range extender device, Grayson Range Extender (GRE) 2.0, is characterized in that it comprises cylindrical paddle cover-based permanent magnets, an armature winding, a charge controller, and a battery bank. Magnetic conductive soft iron and permanent magnets are spaced and are bonded to the inner cylinder wall. The permanent magnets are multi-spoke and in a circular arc, and the magnetic direction that all permanent magnets produce is consistent.

In Device 100 the Armature winding is in the center of the device.

The quantity, shape, and size of the described magnetic conductive soft iron are consistent with the permanent magnet and size of the cylinder.

The cylinder device is positioned fixed on the vehicle body panels, such that the air flow will induce motion in the paddle wheel casing. Air ducts can be molded into the vehicle body panels to encourage and maximize air flow. The cylinder is fixed on the vehicle and as the paddle wheel rotates around the axel the rotor assembly in the cylinder can rotate around stator core casing thereby inducing electricity.

In another embodiment, a kind of electric vehicle recharging system that greatly extends the range of any vehicle is also provided, wherein said paddle-based range extender device, the Grayson Range Extender (GRE) 2.0 described above, is characterized in that the permanent magnet and magnetic conductive soft iron can be mounted at the center of the cylinder. This then becomes the stator assembly. A rotor phase winding can be wrapped around the inside shell of the cylinder. When the fluid passes the paddle, it spins the cylinder which spins the wire cluster around the magnets in the center of the device which in turn creates a charge in the wire cluster. This charge powers the generator and can be used to recharge the center battery of the device, the vehicle battery or power the vehicle itself.

Because this is a frictionless system, the power produced is scalable to the desired recharge time and range.

### BRIEF DESCRIPTION OF THE DRAWINGS

FIG. 1 shows Device 100, comprising a stator housing armature coil and internal battery paddles. The paddle alignment on the cylindrical device is shown; B) shows the magnets affixed to the inside of the cylinder; C) shows the stator windings; D) shows the battery core; and E) shows the terminals.

FIG. 2 shows Device 200, comprising stator housing permanent magnets and hub-based armature coil rotor permanent magnet rotor: A) shows the position of the paddles; B) shows the relative position of the magnet that is affixed to the inner wall of the cylinder; C) shows the rotor; D) show the shaft that allows the cylinder to spin; E) shows the terminals; F) shows the windings; and G) shows the brushes.

FIG. 3 shows a paddle cylinder generator, particularly the relative position of the paddles to the cylinder.

FIG. 4 shows a sample placement of the device on an electric vehicle.

FIG. 5 shows the stator assembly.

FIG. 6 shows vent ducting.

FIG. 7 shows the internal battery and permanent magnets.

### DETAILED DESCRIPTION

The present invention relates to a kind of paddle-based range extender and recharger for electric vehicles and generating electricity, dramatically increasing the vehicles driving range and greatly reducing or eliminating the need for recharging, this device is called the Grayson Range Extender (GRE) 2.0, belong to electrics technical field.

The primary way to configure this device is denoted in this application as Device 100. In the case of Device 100 this cylindrical device comprises an outer surface which houses the several fluid pressure paddles, rows of magnets that are attached to the inner surface of the cylinder, an inner armature winding that surrounds an internal battery bank. Device 100 the copper or enameled wire is wound tightly around an iron core center and fashioned such that it is encompassed by the paddle cover. This armature takes up a large percentage of the inner device. This assembly constitutes the stator body housing and has electrodes made of soft iron. This armature winding is completely concealed by the paddle wheel cover and is in the shape of the cylinder. This dense magnet wiring cluster forms the first major segment of the Device 100 generator. There are several layers of wire in this cluster. The armature coil is stationary. The magnetic field is created through electric current in the wire-wound coil and strengthened by a soft-iron core. The armature coil assembly converts the mechanical energy of the rotating paddle magnets into electrical energy by passing the permanent magnets through this armature winding. The paddle wheel, which turn the permanent magnets thus becomes the rotor. The Rotor produces rotating magnetic flux or rotating magnetic field associated with the rotor inducing electricity in the armature coil attached to the device or cylinder. The electricity produced is then diverted to the charge controller. The charge controller now powers the engine directly, charges the internal battery or recharges the vehicle battery based on the current needs of the vehicle. Permanent steel magnets attached to the inner wall of the cylinder are arranged at intervals around a center stator hub. Each permanent magnet is attached in sequence with respect to the center hub. Each magnet is adhered to the cylinder alternating the north and south pole orientation of each magnet. They are the second major segment and are arranged in a pattern of five or more spokes and adhered to the paddle wheel. The paddle wheels are designed such that in addition to housing the permanent magnets they transmit the power from the fluid, they represent the third major segment. The magnetic field directions generated by the permanent steel magnets are consistent and all face the inner side or the outer side of the rotor. The internal battery bank comprises the fourth major segment. This segment is hidden in the inside of the stator body.

A cylindrical device that has an outer layer of pressure paddles that are designed to harness the movement of fluids such that the device can convert motion into electricity. The inner wall of the device is lined with magnets which are configured so that they can spin around a center armature winding. The armature winding is comprised of copper or enameled wire that is wound tightly around an iron core and fashioned such that it encompasses a battery bank located in the center of the device. The paddle cover has a series of magnets affixed around the circumference of the inside of the cylinder. The armature makes up the center of the device. This assembly constitutes the stator body housing and has electrodes. This armature winding is completely concealed by the paddle cover. The armature coil assembly converts the mechanical energy of the rotating pressure paddle into electrical energy by passing the permanent magnets through this armature winding. The armature coil surrounds a battery bank. This rechargeable battery bank forms the second major segment of the Device 100 generator.

The pressure paddles are connected to the outside of the cylinder and are arranged such that they can capture the fluid passing over the device and thereby convert the fluid movement into kinetic energy which produces electricity. The pressure paddle assembly thus becomes the rotor. The Rotor produces rotating magnetic flux or rotating magnetic field associated with the rotor inducing electricity in the armature coil attached to the device. The electricity produced is then diverted to the charge controller. The charge controller now powers the engine directly, recharges the internal battery or recharges the vehicle battery based on the current needs of the vehicle. Pressure paddles are arranged at intervals around a cylindrical device. Each permanent magnet is attached in sequence to the inside wall of the cylindrical device. Each magnet is adhered to the inside wall of the cylindrical device alternating the north and south pole orientation of each magnet. They are arranged in a pattern of five or more and adhered to the inside of the cylinder. The paddles are designed such that in addition to rotating the permanent magnets they transmit the power from the fluid to the device. The pressure paddle cylindrical case performs two functions. To hold the entire device. The whole weight of the device is concentrated on the center hub. The cylinder holds this hub and transfer the weight to center. The entirety of the inside of the cylinder case is covered by permanent magnets. The magnetic field directions generated by the permanent steel magnets are consistent and all face the inner side or the outer side of the rotor. A kind of frictionless paddle-based range extender and recharger for electric vehicles and generating electricity, dramatically increasing the electric vehicle driving range and greatly reducing or eliminating the need for recharging, effectively lowering the sprung weight of the vehicle and speeding recharge times. This paddle-based device creates magnetic lines inducing current. Electrical conductors moving through a steady magnetic field, or stationary conductors within a changing magnetic field, will have circular currents induced within them by induction, called eddy currents. Eddy currents flow in closed loops in planes perpendicular to the magnetic field.

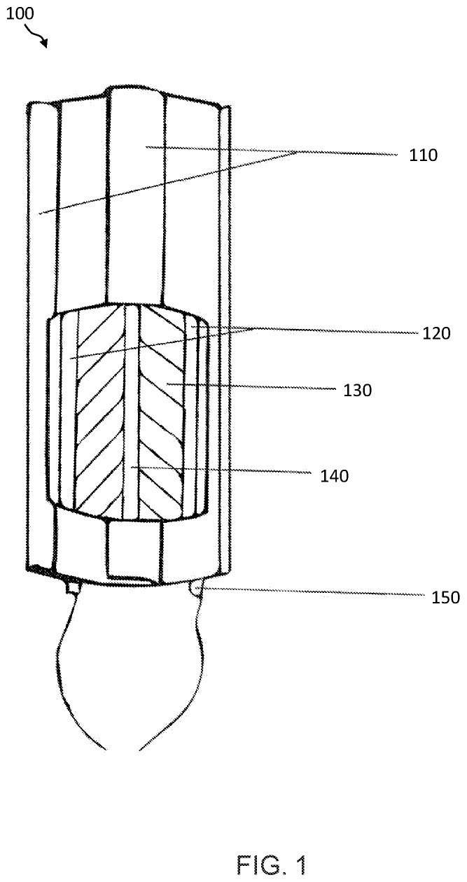

Referring now to FIG. 1, a sectional view is provided of a kind of paddle-type electric vehicle generator range extender and recharger of the present invention, the Grayson Range Extender (GRE 2.0), wherein:

(1) Device 100 comprises paddles 110, magnets 120, stator windings 130, an internal battery 140, and terminals 150. In the case of Device 100 the magnet wire or enameled wire is wound tightly around an iron core and fashioned such that it is encompasses an internal battery bank by the cylinder with paddle cover. This armature takes up a large percentage of the inside of the cylinder. This assembly constitutes the stator body housing. This armature winding is completely concealed by the paddle wheel cover and is in the shape of a cylinder. This dense magnet wiring cluster forms the first major segment of the Device 100 generator. There are several layers of wire in this cluster. The armature coil is stationary.

(2) The rotor is comprised of permanent magnets which are incorporated in the rotating cylinder.

(3) The armature coil assembly converts the mechanical energy of the rotating cylinder into electrical energy by passing the magnets through this armature winding.

Said cylinder, which houses the permanent magnets in the underside. The cylinder thus becomes the rotor. The Rotor produces rotating magnetic flux or rotating magnetic field associated with the rotor inducing electricity in the armature coil attached to the paddle wheel.

(4) Electrodes made of soft iron and permanent steel magnets are arranged at intervals around the inside of the paddle wheel. Each permanent magnet is attached in sequence to the upper portion of the cylinder. Each magnet is placed on the inside of the paddle wheel alternating the north and south pole of each magnet. They are arranged in a pattern of four or more spokes and adhered on the upper side of the paddle wheel. The paddles are designed such that in addition to moving the permanent magnets they transmit the power from the fluid hub to the battery.

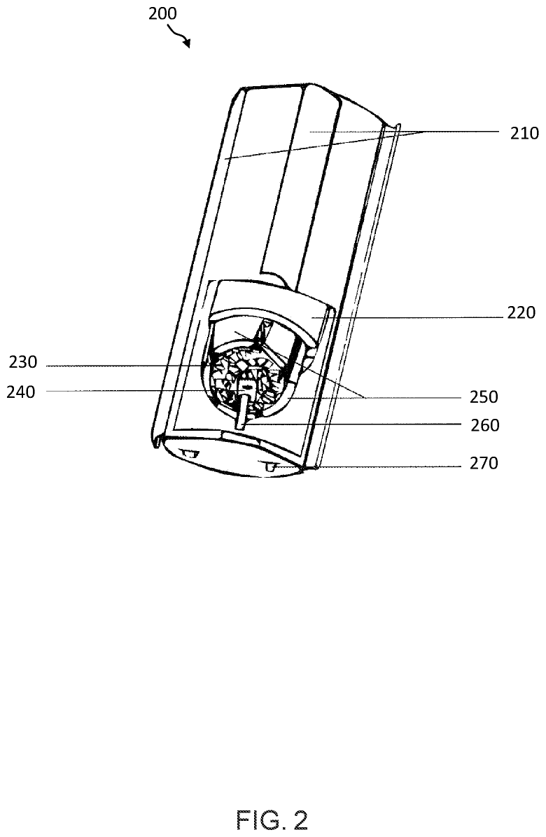

Referring now to FIG. 2, a sectional view of a kind of paddle wheel-type electric vehicle generator range extender and recharger of the present invention, the Grayson Range Extender (GRE), is provided wherein:

(1) Device 200 comprises paddles 210, magnets 220, windings 230, brushes 240, a rotor 250, a shaft 260, and terminals 270. In the case of Device 200 the magnet wire or enameled wire is wound tightly around an iron core and fashioned such that it encompasses the internal battery. This armature winding takes up a large percentage of the inside of the cylinder. This assembly constitutes the stator. This dense magnet wiring cluster forms the first major segment of the Device 100 generator. There are several layers of wire in this cluster. The stator is comprised of wiring clusters around each center hub.

(2) The magnetic rotor converts the mechanical energy of the rotating paddle cylinder into electrical energy by passing the permanent magnet cluster through the armature winding.

(3) Said paddle wheel, which houses the permanent magnet. The paddle wheel thus becomes the rotor. The Rotor produces rotating magnetic flux or rotating magnetic field associated with the rotor inducing electricity in the permanent magnet cluster attached to the paddle wheel.

(4) Electrodes made of soft iron and tightly wired armature spokes are arranged at intervals around a center internal battery hub. Each armature spoke is attached in sequence to the center hub.

(5) The stator is comprised of permanent magnets which are incorporated in the center of the paddle wheel. The stator assembly converts the mechanical energy of the rotating paddle into electrical energy by passing the permanent magnet assembly through the armature coil. The magnetic paddle wheel cluster is placed attached to the inside of the cylinder well alternating the north and south pole of each magnet.

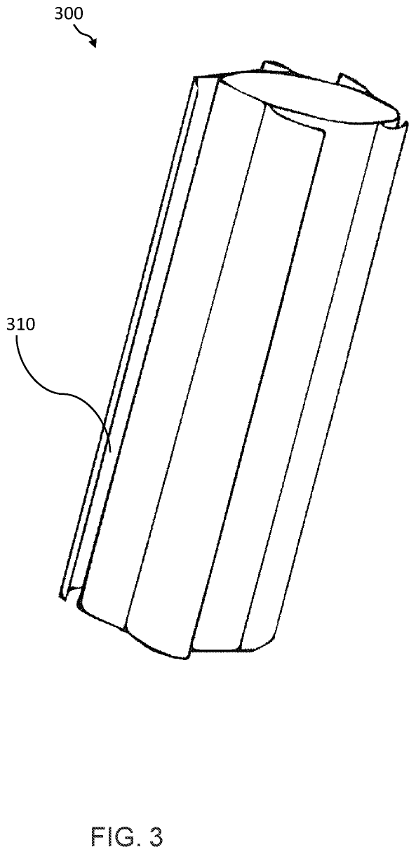

Referring now to FIG. 3, a view is provided of a kind of paddle wheel-type electric vehicle generator range extender and recharger of the present invention, the Grayson Range Extender (GRE 2.0), wherein the outside of the cylinder generator 300 is symmetrically covered with contoured paddles 310 that capture the fluid motion and rotate the permanent magnets around the center stator housing.

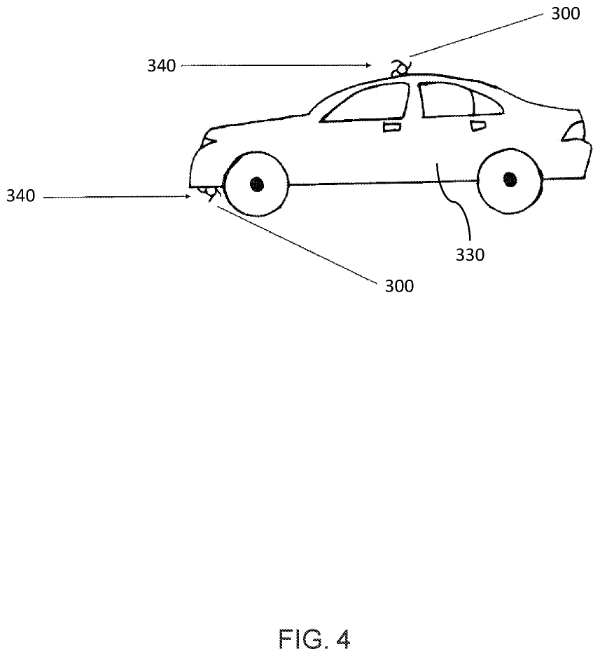

Referring now to FIG. 4, a view of a kind of wheel-type electric vehicle generator range extender and recharger of the present invention, the Grayson Range Extender (GRE 2.0), wherein a sample placement of the cylinder device 300 on a sample electric vehicle 330 is provided. The device in this example is placed such that the device maximizes its ability to collect the wind 340 generated by the moving vehicle.

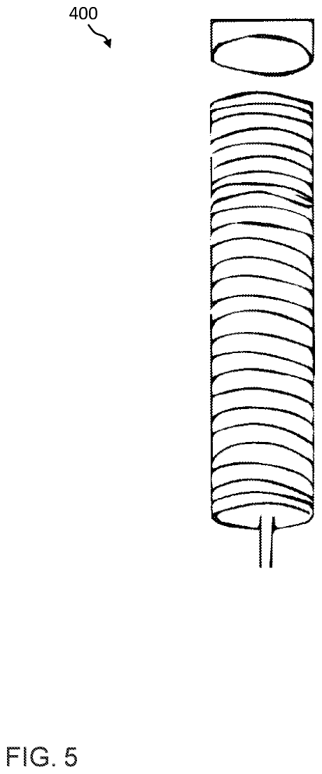

Referring now to FIG. 5, a view is provided of the stator assembly 400, which is wound around the internal magnet. The rotor will create magnetic lines inducing current in the stator assembly. Electrical conductors moving through a steady magnetic field, or stationary conductors within a changing magnetic field, will have circular currents induced within them by induction, called eddy currents. Eddy currents flow in closed loops in planes perpendicular to the magnetic field.

The stator assembly is connected to a Charge Controller. The electricity produced is then diverted to the charge controller. The charge controller now powers the engine directly or recharges the battery based on the needs of the pre-programmed needs vehicle. A charge controller, charge regulator or battery regulator limits the rate at which electric current is added to or drawn from electric batteries. It prevents overcharging and may protect against overvoltage, which can reduce battery performance or lifespan and may pose a safety risk. It may also prevent completely draining (“deep discharging”) a battery, or perform controlled discharges, depending on the battery technology, to protect battery life. The terms “charge controller” or “charge regulator” may refer to either a stand-alone device, or to control circuitry integrated within a battery pack, battery-powered device, or battery charger. The charge controllers may also be called a power regulator. The charge controller has additional features, such as a low voltage disconnect (LVD), a separate circuit which powers down the load when the batteries become overly discharged (some battery chemistries are such that over-discharge can ruin the battery). A series charge controller or series regulator disables further current flow into batteries when they are full. A shunt charge controller or shunt regulator diverts excess electricity to an auxiliary or “shunt” load, such as an electric water heater, when batteries are full. Simple charge controllers stop charging a battery when they exceed a set high voltage level, and re-enable charging when battery voltage drops back below that level. Pulse width modulation (PWM) and maximum power point tracker (MPPT) technologies are more electronically sophisticated, adjusting charging rates depending on the battery's level, to allow charging closer to its maximum capacity. A charge controller with MPPT capability frees the system designer from closely matching available PV voltage to battery voltage. Considerable efficiency gains can be achieved, particularly when the PV array is located at some distance from the battery. By way of example, a 150 volt PV array connected to an MPPT charge controller can be used to charge a 24 or 48 volt battery. Higher array voltage means lower array current, so the savings in wiring costs can more than pay for the controller. Charge controllers may also monitor battery temperature to prevent overheating. Some charge controller systems also display data, transmit data to remote displays, and data logging to track electric flow over time. Circuitry that functions as a charge regulator controller may consist of several electrical components, or may be encapsulated in a single microchip, an integrated circuit (IC) usually called a charge controller IC or charge control IC.

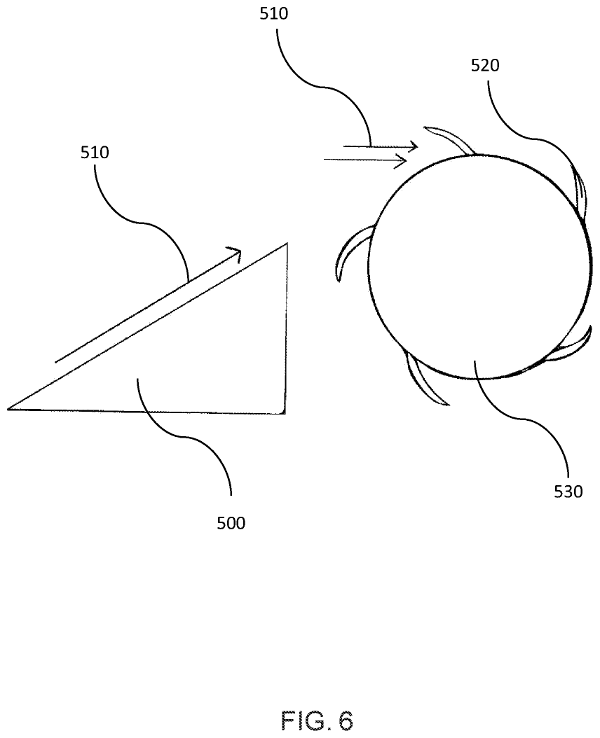

Referring now to FIG. 6, a sectional view of a ducting vent of a kind of wheel-type electric vehicle generator range extender and recharger of the present invention, the Grayson Range Extender (GRE) is provided, wherein the fluid flow is controlled and minimized by using but not limited to ducting, tubes, and ramps. In this example the ramp 500 is positioned so that the flow of fluids 510 strikes the paddle 520 at the right geometry for maximum rotational energy of the cylinder generator 530.

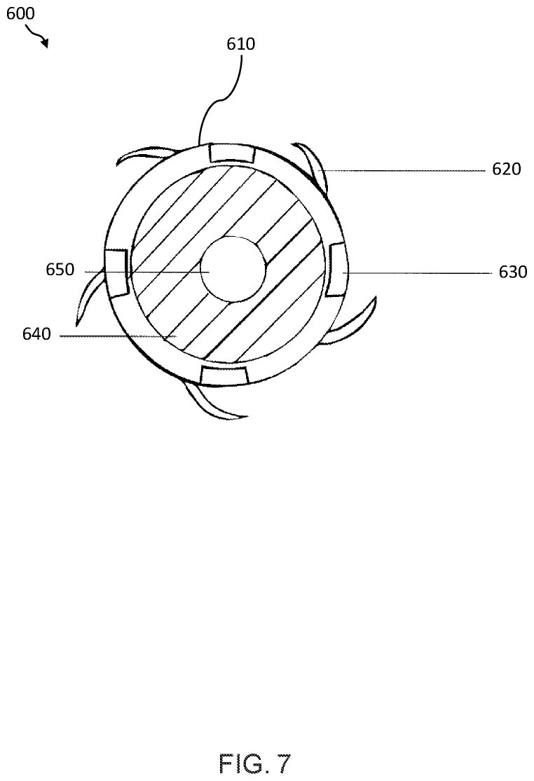

Referring now to FIG. 7, a sectional view of a sample paddle placement on a movable front paddle wheel 600 is provided, which is a kind of wheel-type electric vehicle generator range extender and recharger of the present invention, the Grayson Range Extender (GRE), wherein:

(1) the contoured paddles 620 are placed on the outside of the cylinder 610;

(2) the permanent magnets 630 are secured to the inner wall of the cylinder;

(3) the stator windings 640 occupy the interior of the device; and

(4) the internal battery 650 is located at the very center of the device.

In another embodiment, a kind of wheel-type electric vehicle generator range extender and recharger of the present invention, the Grayson Range Extender (GRE), is provided which comprises a trailer tethered to the electric vehicle. The trailer comprises a rotating wheel-based rotor and the rotational energy of the moving trailer powers the generator. The positioning of the generator in the trailer enables the use of a gear multiplier, whereby the motion of the wheel spins a gear connected to a gear multiplier, which is in turn connected to a shaft that powers the generator. The gear multiplier increases the rotational speed of the device, wherein the electricity is used to power the electric vehicle or recharge the battery bank.

In another embodiment, a kind of wheel-type electric vehicle generator range extender and recharger of the present invention, the Grayson Range Extender (GRE), is provided which comprises a trailer tethered to the electric vehicle. The trailer comprises a rotating wheel-based rotor and the rotational energy of the moving trailer powers the generator, wherein the electricity is used to power the electric vehicle or recharge the battery bank.

Permanent magnet has multi-disc and in circular arc, the magnetic direction that all permanent magnets produce is consistent, Quantity, the shape and size of described magnetic conductive soft iron are consistent with permanent magnet.

The motor generator proposed the present invention carries out the explanation of operation principle.

Motor basic functional principle of the present invention is identical with traditional permanent magnet generator.

Beneficial effects of the present invention include:

(1) system increases the range of an electric vehicle up to 400%;

(2) compared with traditional range extenders this device requires no additional fuels;

(3) compared with traditional generators this device has much greater charging capacity and reliability;

(4) compared with other types of recharging systems like regenerative breaking and bike generators, this system has lower coefficient of friction, generates a negligible amount of heat and is infinitely more reliable;

(5) can be very applicable and installed on all existing Electric Vehicles;

(6) compared to other range extenders this device lowers the sprung weight of the vehicle; and

(7) compared to other range extenders this device has zero emissions.

It is to be noted that the subject matter of the present invention may be embodied in many different forms and should not be construed as limited to the embodiments set forth herein. Indeed, many modifications and other embodiments of the subject matter of the present invention set forth herein will come to mind to one skilled in the art to which the subject matter of the present invention pertains having the benefit of the teachings presented in the foregoing descriptions and the associated drawings. Therefore, it is to be understood that the subject matter of the present invention is not to be limited to the specific embodiments disclosed and that modifications and other embodiments are intended to be included within the scope of the appended claims.

What is claimed is:

1. A fluid dynamic, electricity producing, paddle-based, electric vehicle range extender and recharging system comprising:
a) a cylinder comprising a cylinder outside and a cylinder inside, wherein pressure paddles are connected to the cylinder outside and permanent magnets are connected to the cylinder inside;
b) a fluid directional ramp, gate, and/or ducting enclosure configured to ensure that the fluid strikes the pressure paddles at an optimal angle and to direct and compress a fluid to pass over the pressure paddles with enhanced efficiency and pressure;
c) a stator armature coil wrapped around a charge controller; and
e) a battery bank inside the stator armature coil;
wherein the system is configured such that when the fluid strikes the paddles, the cylinder rotates the permanent magnets around the stator armature coil to serve as a rotor that produces a rotating magnetic flux or a rotating magnetic field that induces electricity in the stator armature coil, and wherein the electricity is diverted the charge controller for powering the electric vehicle directly, for recharging the battery bank, or for recharging the electric vehicle's battery based on the electric vehicle's current needs.

2. The electric vehicle range extender and recharging system of claim 1, wherein the permanent magnets are multi-spoke and positioned in a circular arc with the magnetic direction of each of the permanent magnets consistent with one another.

3. The electric vehicle range extender and recharging system of claim 1, wherein the permanent magnets are arranged in a pattern alternating the north and south pole orientation of each permanent magnet.

4. The electric vehicle range extender and recharging system of claim 1, wherein the stator armature coil is positioned in the center of the cylinder.

5. The electric vehicle range extender and recharging system of claim 1, wherein the cylinder is fixed on a body panel of the electric vehicle.

6. The electric vehicle range extender and recharging system of claim 1, wherein the fluid directional ramp, gate, and/or ducting enclosure is molded into a body panel or the electric vehicle.

7. The electric vehicle range extender and recharging system of claim 1, wherein the stator armature coil comprises a coiled copper, magnetic, or enameled wire wound around a stator armature.
